(19) United States
(12) Patent Application Publication
(10) Pub. No.: US 2007/0089305 A1
(43) Pub. Date: Apr. 26, 2007

(54) Ultimate drywall square

(76) Inventors: Jay Poyser, Whitby (CA); Peter C. Poyser, San Diego, CA (US)

Correspondence Address: PETER POYSER, 1455 2ND AVE, SAN DIEGO, CA, 92101, US

(21) Appl. No.: 11/091,093

(22) Filed: Jun. 9, 2005

(51) Int. Cl. B43L 13/02

(52) U.S. Cl. 33/41.1

(57) ABSTRACT

All existing drywall square designs do not allow for quick & accurate marking nor do they possess the ability to hold onto the square to help in the accurate marking and measuring because they are simply flat metal. Existing drywall squares do not have the ability to provide angle measurements such is required, for example, in sloping roof structures.

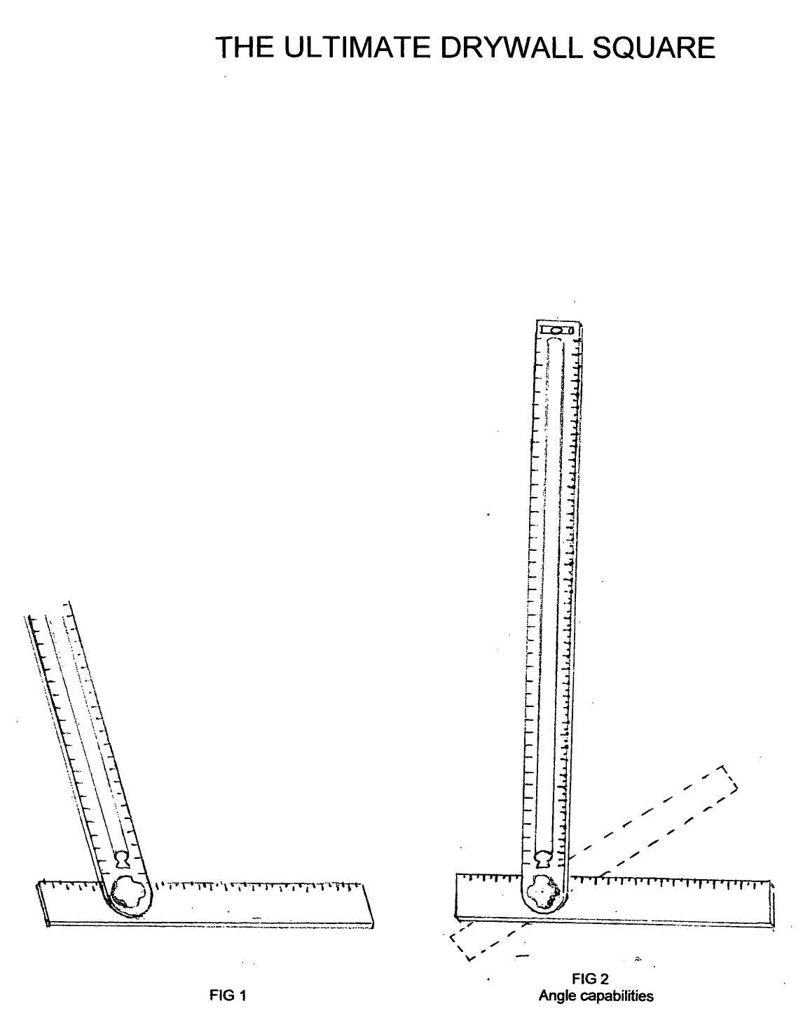

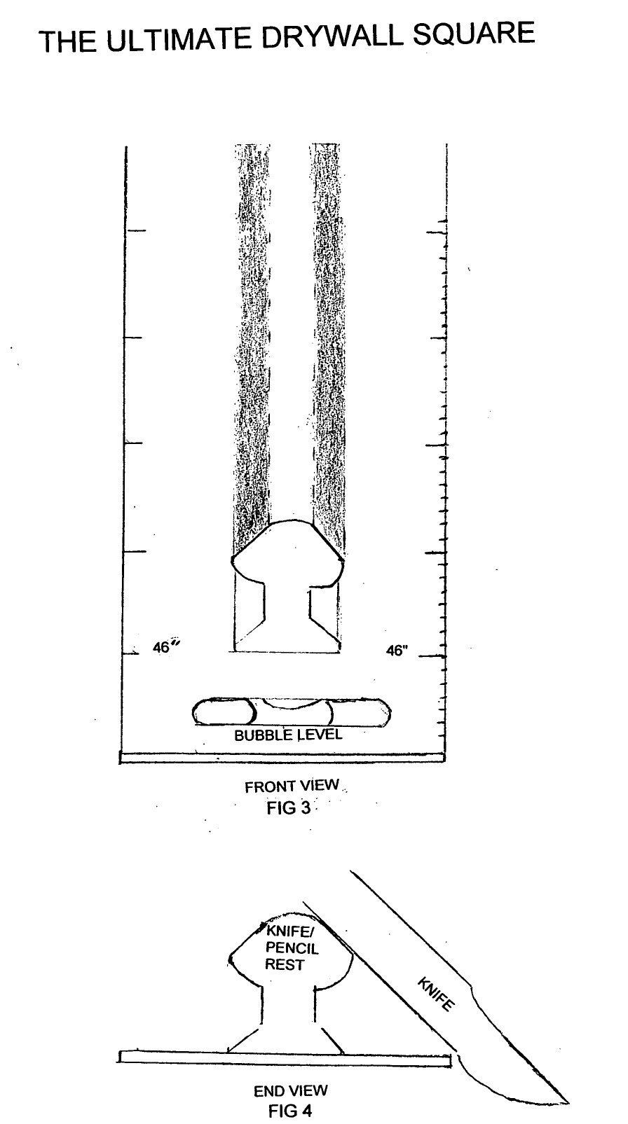

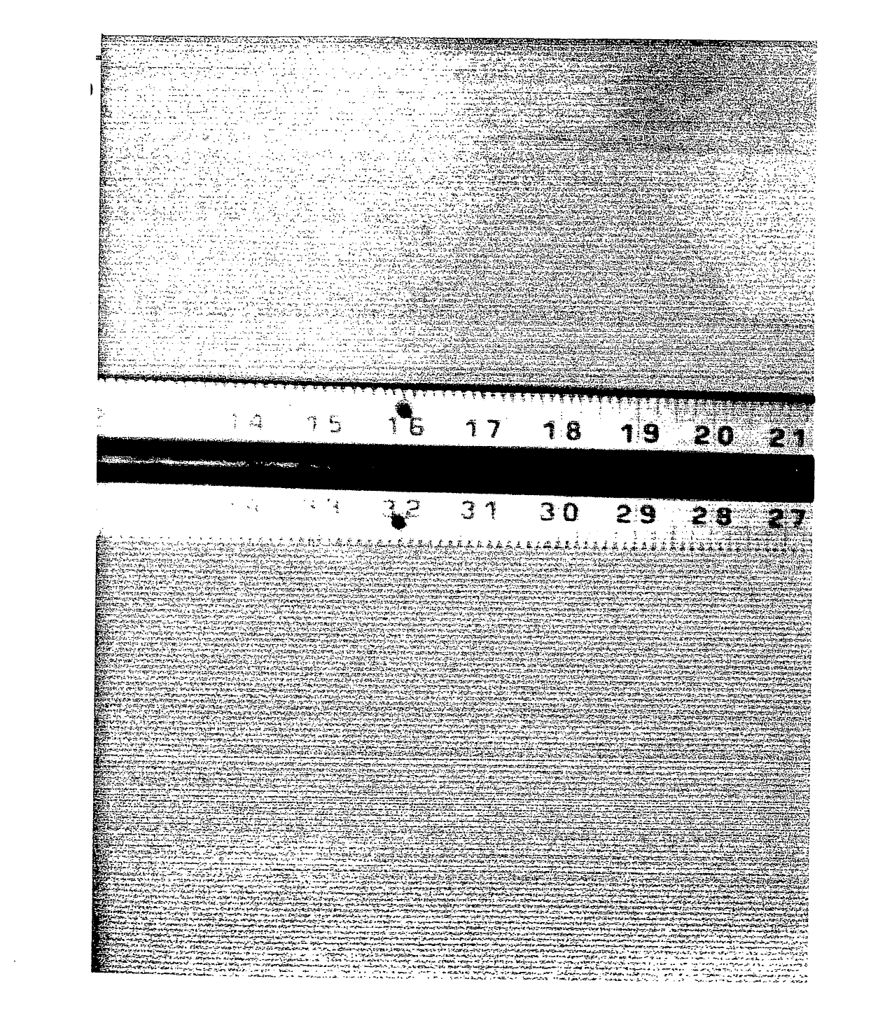

Unlike other drywall squares, the ‘Ultimate’ drywall square possesses the capabilities to:
1) Position a knife or pencil accurately for cutting or marking due to the beveled notches positioned every ⅛″ along the edge of the straight edge.
2) Assist in accurately cutting and marking with the help of an opposable handle along the length of the straight edge.
3) Locate and mark studs easily with 3/16 holes located at 16″ & 32″
4) Mark drywall where angles are required with the angle finder
5) Bubble level to accurately find angles
6) User friendly for right or left handed operators

The above improvements result in the operator being able to push on the drywall board while sliding the square backwards to mark any point with a knife or pencil, at ⅛ intervals along the 46″ length. A pencil mark at either 16″ or 32″ holes will quickly mark stud centers. Use the angle finder by loosening the nut so that the top of the square pivots, place the top of the square against the ceiling that is angled. Then use the bubble level to level, bring down, tighten, place on drywall board and cut.

1) To position knife or pencil accurately for cutting or marking due to bevelled notches positioned every ⅛″ along both sides of straight edge.

2) Possesses opposable handle on straight edge for easy holding and more accurate marking.

3) Bubble level included to accurately find angles.

4) Angle finder to mark drywall where angles are required.
